(19) United States
(12) Patent Application Publication
(10) Pub. No.: US 2014/0209249 A1
(43) Pub. Date: Jul. 31, 2014

(54) LABELING MACHINE, PARTICULARLY OF THE REEL-FED TYPE

(71) Applicants: Giovanni Bevilacqua, Castellucchio (Mantova) (IT); Ireneo Orlandi, Castellucchio (Mantova) (IT); Ivan Di Pinto, Castellucchio (Mantova) (IT); Sofia Paolo Lanfredi, Castellucchio (Mantova) (IT); Damiano Fabbri, Castellucchio (Mantova) (IT); Gabriele Stocchi, Castellucchio (Mantova) (IT); Antonio Peruffo, Castellucchio (Mantova) (IT); Andrea Zanardi, Castellucchio (Mantova) (IT)

(72) Inventors: Giovanni Bevilacqua, Castellucchio (Mantova) (IT); Ireneo Orlandi, Castellucchio (Mantova) (IT); Ivan Di Pinto, Castellucchio (Mantova) (IT); Sofia Paolo Lanfredi, Castellucchio (Mantova) (IT); Damiano Fabbri, Castellucchio (Mantova) (IT); Gabriele Stocchi, Castellucchio (Mantova) (IT); Antonio Peruffo, Castellucchio (Mantova) (IT); Andrea Zanardi, Castellucchio (Mantova) (IT)

(73) Assignee: Z-Italia S.R.L., Castellucchio (Mantova) (IT)

(21) Appl. No.: 14/342,109

(22) PCT Filed: Sep. 11, 2012
(86) PCT No.: PCT/EP2012/003803

§ 371 Date: Feb. 28, 2014

(30) Foreign Application Priority Data
Sep. 16, 2011 (IT) VI2011A000250

(51) Int. Cl. B65C 9/18

(52) U.S. Cl. CPC B65C 9/18
USPC 156/539

(57) ABSTRACT

A labeling machine, particularly of the reel-fed type, includes a framework (2) which supports an application element (10) provided with at least one rotating member (11) adapted to transfer the individual labels on corresponding containers moved by a conveyance element (50); the application assembly is fed by a driving element (20) which unwinds the ribbon of the labels from a reel which is supported by a rotatable support (31) mounted on at least one reel supporting assembly (30). The labeling machine includes an articulation element (100) in order to move reversibly the reel supporting assembly from a working position, in which the rotation axis (3000) of the rotatable support is substantially parallel to the rotation axis (1000) of the rotating member, to a loading position, in which the rotation axis of the rotatable support is transverse to the rotation axis of the rotating member.

The present invention relates to a labeling machine, particularly of the reel-fed type.

It is known that there are labeling machines for applying labels to cylindrical or contoured containers. The labels are obtained by cutting portions of appropriate length from a continuous ribbon wound on a reel.

In general, those machines comprise an application device constituted essentially by a drum, which rotates about a vertical rotation axis and is adapted to transfer each individual label onto a container to be labeled, which is made available by adapted conveying systems.

The application device is fed by driving elements, which unwind the ribbon of the labels from reels which are traditionally supported by one or more reel holders, which can rotate about substantially vertical rotation axes.

The ribbon can be pre-adhesive or at least partially spread with adhesive on the face designed to adhere to the containers to be labeled, or can lack adhesive and in this case the labeling machine is also equipped with an adapted adhesive bonding means.

EP2196397 discloses an apparatus for applying labels supplied from a roll to containers. The apparatus has a container feeding unit, a container table, a container removal device, and a labeling unit. A cutting device is variably controlled in such a manner that labels are separated by roller with respect to its length according to periphery of a container. The length is smaller than the periphery of the container.

Although they are advantageous in various respects and substantially meet the purpose, conventional labeling machines have the problem of loading heavy and bulky reels onto the respective holders and to ensure maximum safety for the operators.

The inefficiency of the conventional machines in that respect is also relevant from the point of view of minimizing the time required for the operations that are auxiliary to labeling.

The aim of the invention is to solve the problems described above, providing a labeling machine, particularly of the reel-fed type, that is capable of making the operations for loading the reels on the reel holders particularly easy, even in the case of heavy and bulky reels.

Within the scope of this aim, a particular object of the invention is to provide a labeling machine that is capable of ensuring maximum safety for the operators.

A further object of the invention is to provide a labeling machine that allows to minimize the times of the operations that are auxiliary to labeling.

A further object of the invention is to provide a labeling machine that allows to perform the reel loading and unloading operations by ensuring limited and repeatable machine downtimes.

This aim, these objects and others which will become better apparent hereinafter are achieved by a labeling machine, particularly of the reel-fed type, comprising a framework which supports an application means provided with at least one rotating member adapted to transfer individual labels on corresponding containers moved by a conveyance means; said application assembly is fed by a driving means which unwinds a labels ribbon from a reel which is supported by a rotatable support mounted on at least one reel supporting assembly; said labeling machine is characterized in that it comprises an articulation means which moves said reel supporting assembly from a working position to a loading position and vice versa; in said working position, a rotation axis of said rotatable support is substantially parallel to a rotation axis of said rotating member, whereas in said loading position, the rotation axis of said rotatable support is transverse to the rotation axis of said rotating member.

Further characteristics and advantages will become better apparent from the description of preferred but not exclusive embodiments of a labeling machine according to the invention, illustrated by way of non-limiting example in the accompanying drawings, wherein:

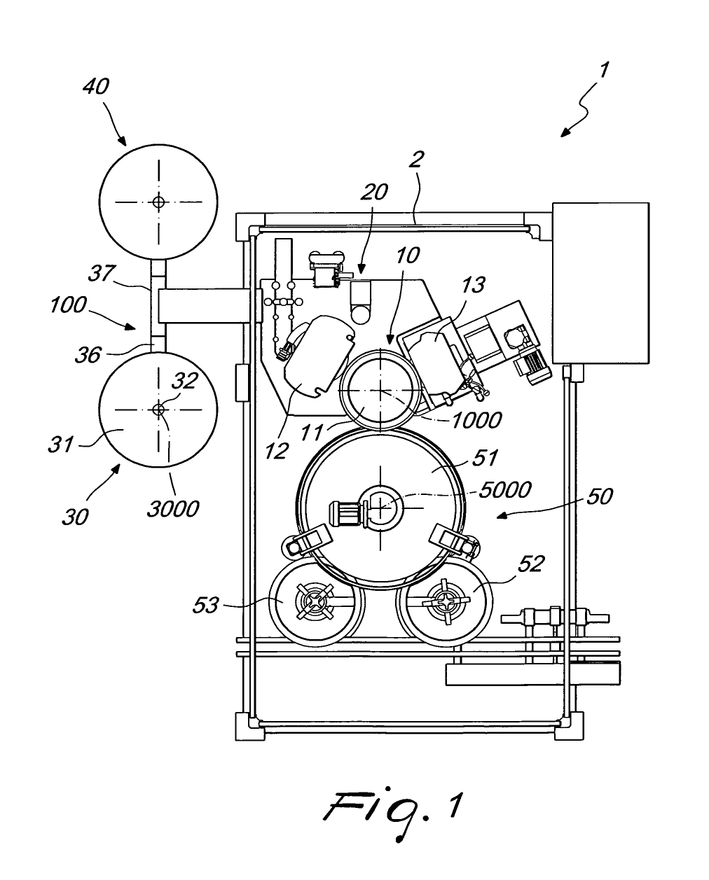

FIG. 1 is a schematic top view of a labeling machine according to the invention, in a working position;

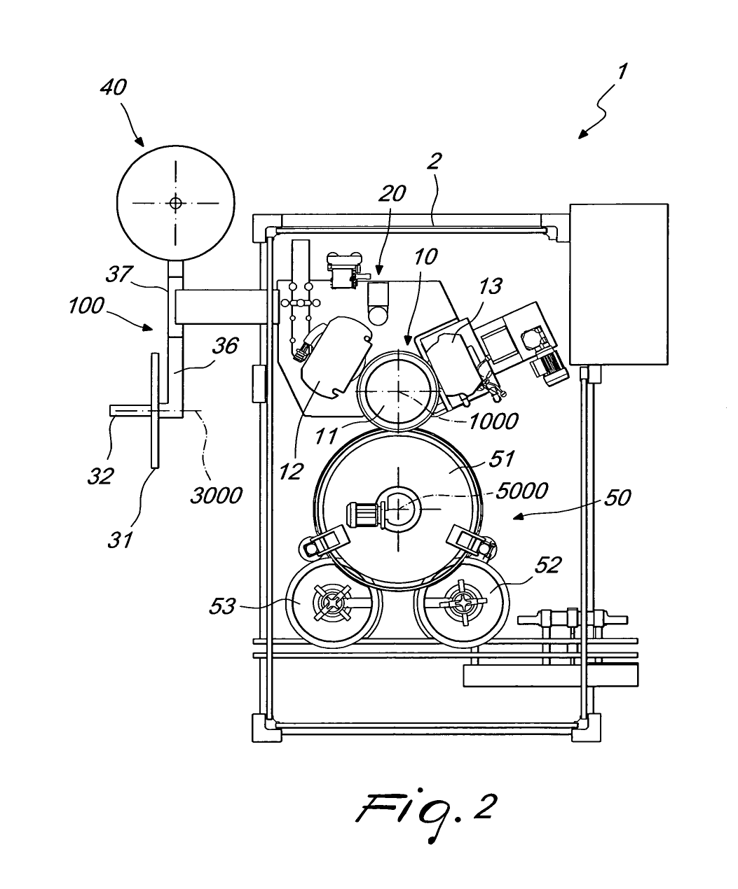

FIG. 2 is a schematic top view of the labeling machine according to the invention, in a loading position;

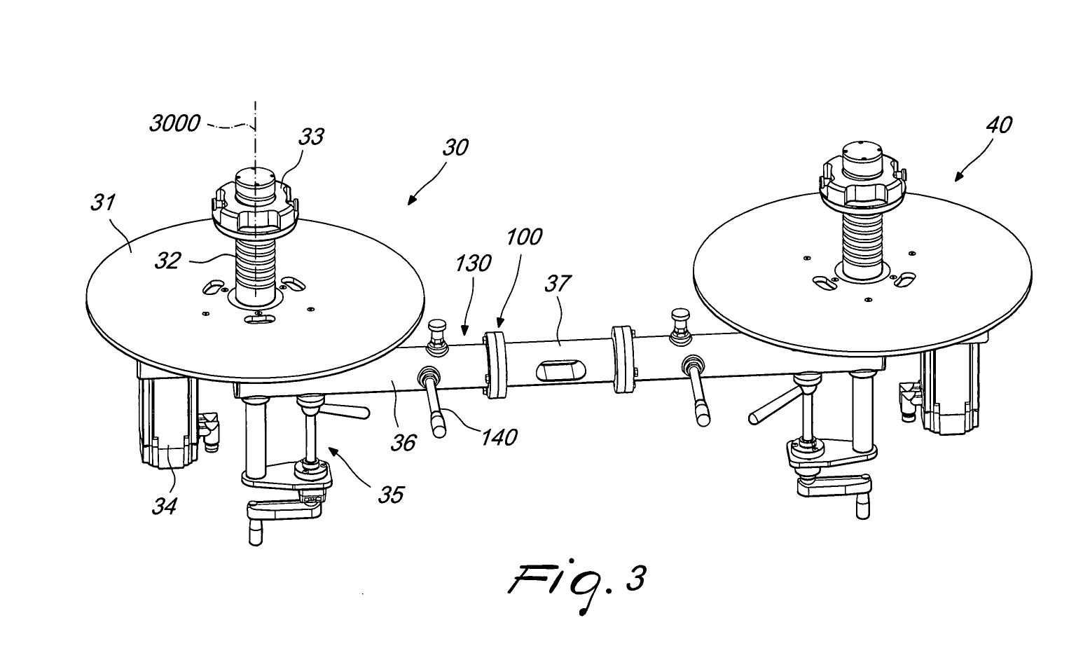

FIG. 3 is a perspective view of a component of the labeling machine according to the invention;

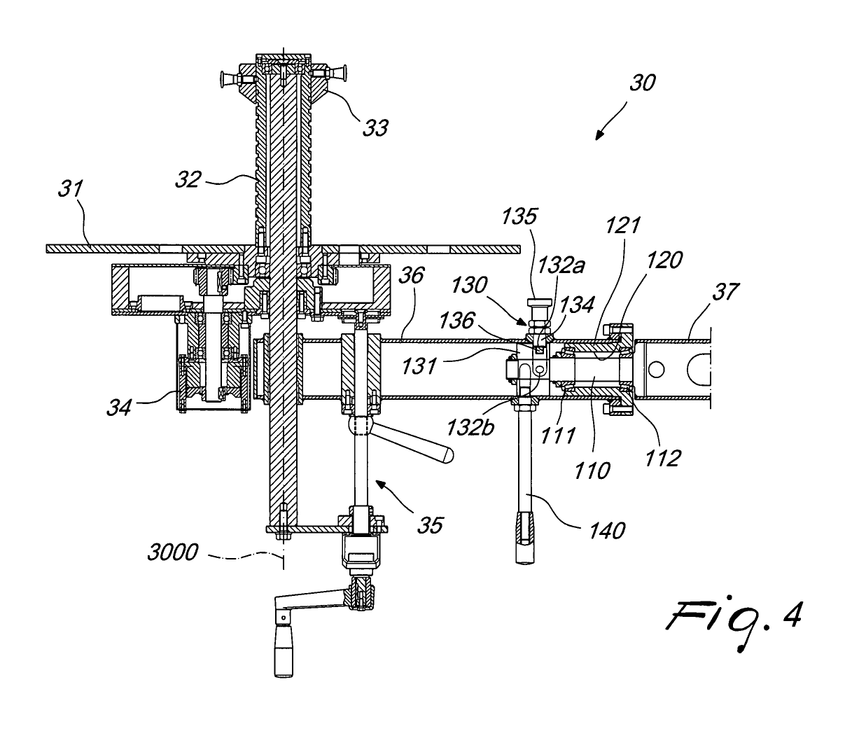

FIG. 4 is a sectional view of the component of FIG. 3;

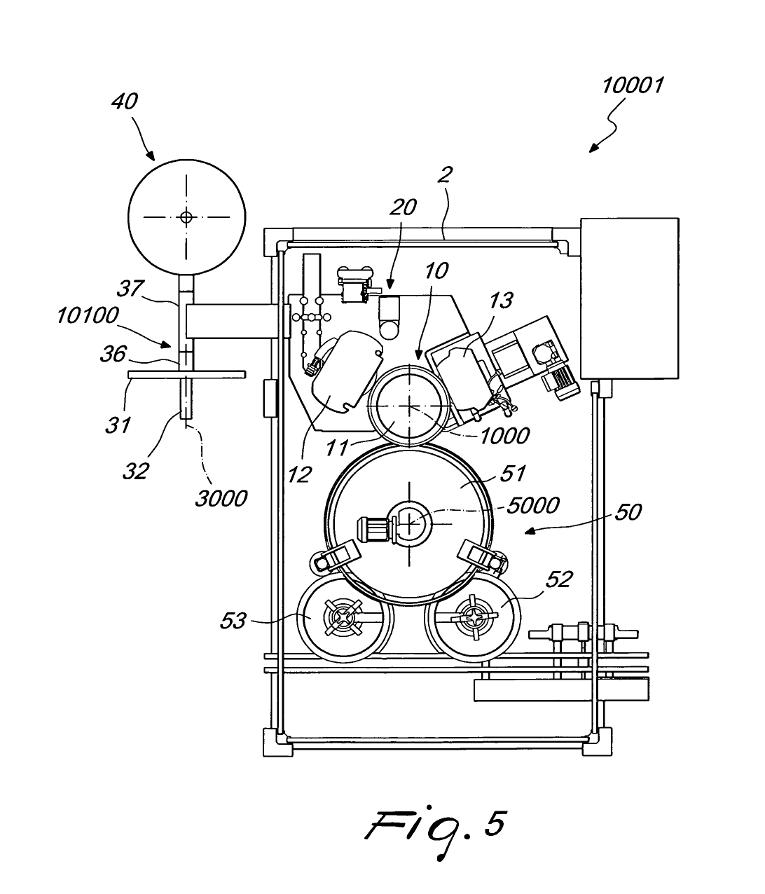

FIG. 5 is a schematic top view of a further embodiment of the labeling machine according to the invention, in the loading position.

With reference to FIGS. 1 to 4, the labeling machine, particularly of the reel-fed type, generally designated by the reference numeral 1, comprises an application means 10 mounted on a framework 2. The application means 10 is adapted to transfer the individual labels onto corresponding containers which are moved by an adapted conveyance means 50.

By way of example, the conveyance means 50 comprises a carousel 51, which rotates about a substantially vertical rotation axis 5000 and is equipped with a series of container supporting trays, which are arranged peripherally and are made to rotate.

The carousel 51 is assisted by an input star conveyor 52, which provides the containers to be labeled, and by an output star conveyor 53, which evacuates the labeled containers.

In any case, it is important to point out that the present invention might also be used on labeling machines equipped with a conveyance means of a different type.

The application means has a rotating member 11 which is tangent to the carousel 51 and rotates about a rotation axis 1000, which is substantially parallel to the rotation axis 5000 of the carousel 51.

The rotating member 11 has a substantially cylindrical shape and multiple holes are provided on its lateral surface and are connected to an adapted pneumatic means, not shown in the accompanying figures.

The pneumatic means transfers each label onto the container to be labeled or retains it so that it adheres on the surface of the rotating member 11, as a function of the angular position assumed by the rotating member with respect to the container.

Preferably, the application means 10 also comprises a cutting means 12, which forms each individual label from the ribbon portions. Each label ribbon portion is coated with adhesive by an adhesive bonding means 13.

The herewith described example refers to a labeling machine adapted to treat a ribbon of labels which is not pre-adhesive; however, the present invention may also be used with machines adapted to use pre-adhesive ribbons. Of course, in a labeling machine preset for the use of pre-adhesive ribbons, the adhesive bonding means 13 would be absent, while the application means 10 might include the cutting means 12.

The application means 10 is fed by a driving means 20, which is preferably assisted by a system for controlling tension and position.

The traction means 20 unwinds the labels ribbon from a reel which is supported by a rotatable support 31, mounted on a first reel supporting assembly 30.

According to a preferred embodiment of the invention, the labeling machine 1 is also equipped with a second reel supporting assembly 40, which is substantially identical to the first reel supporting assembly 30.

Bearing in mind the equivalence and considering that, in a practical embodiment, the labeling machine might comprise only the first reel supporting assembly 30, only the first reel supporting assembly 30 is described in detail.

The rotatable support 31 is constituted by a disk-like body from which a shaft 32 protrudes centrally, the reel being fitted thereon.

A locking cone 33 is fitted on the shaft 32 in an adjustable position and fixes the reel on the rotatable support 31, while keeping the reel centered with respect to the shaft 32.

In order to ensure a regular unwinding of the ribbon, even with high production rates, the rotatable support 31 is moved by a servomotor 34, which turns it about a rotation axis 3000.

If the labeling machine 1 has a more limited production rate, or is adapted o treat a ribbon that is less extensible, a braking device is installed instead of the servomotor 34.

In a working position, the rotation axis 3000 of the rotatable support 31 is substantially parallel to the rotation axis 1000 of the rotating element 11 and therefore its orientation is substantially vertical.

In the working position, the height of the rotatable support 31 with respect to the ground can be adjusted micrometrically by virtue of an adjustment means 35 which acts on the shaft 32.

According to the invention, the labeling machine 1 comprises an articulation means 100, which allows to move the reel supporting assembly 30 from the working position, described above, to a loading position and vice versa.

In the loading position, the rotation axis 3000 of the rotatable support 31 is arranged transversely to the rotation axis 1000 of the rotating element 11, until it is in an extreme case in a substantially horizontal position.

It is evident that this position considerably facilitates the reel replacement operations, especially if it is necessary to insert on the shaft 32 a reel that is particularly heavy or bulky.

In more detail, the articulation means 100 is arranged substantially at the connecting region between the movable part 36 and the fixed part 37 of an arm supporting the equipment of the reel supporting assembly 30.

While the fixed part 37 is integral with the framework 2, the movable part 36 is associated with the rotating support 31 and with the rest of the components that support and move the reel.

The articulation means 100 comprises a pivot 110, which is rotatably accommodated within a substantially complementarily shaped seat 120.

Preferably, the pivot 110 is provided at the axial end of the fixed part 37 and the seat 120 is formed at a hollow portion of the movable part 36.

However, the pivot 110 may also be provided in the movable part 36 and the seat 120 may be provided in the fixed part 37.

The seat 120 is provided with a flanged sleeve 121, which is inserted in the hollow portion of the movable part 36 and is detachably fastened to the end of the movable part 36.

The flanged sleeve 121 accommodates a friction reducing means constituted by a pair of bearings 111 and 112. The pivot 110 is rotatably mounted on bearings 111 and 112.

A removable locking means 130 acts between the movable part 36 and the fixed part 37. The removable locking means 130 comprises a cylindrical body 131 provided with at least two locking seats 132a and 132b, which are adapted to interfere with a corresponding detent 134.

The cylindrical body 131 is arranged inside the hollow portion of the movable part 36 and is fastened to the end of the pivot 110, that protrudes beyond the bottom of the flanged sleeve 121.

A slot is formed circumferentially with respect to the cylindrical body 131, and two mutually transverse dead holes are provided at the ends of the slot and constitute the two locking seats 132a and 132b.

The detent 134 comprises a cylinder which is associated with the movable part 36 so as to be free to slide radially with respect to the cylindrical body 131.

The cylinder has, at its accessible end, a knob 135 and, at the opposite end, a shank 136 which can be inserted in the locking seats 132a and 132b.

The extraction of the shank 136 from the locking seats 132a and 132b, which is required in order to pass from the working position to the loading position and vice versa, occurs by overcoming the action of an elastic contrast means.

In order to facilitate the transition, an operating lever 140 may be joined to the movable part 36.

According to a further embodiment of the invention, which is shown schematically in FIG. 5, in which the labeling machine according to the invention has been designated by the reference numeral 10001, the articulation means 10100 assumes essentially the configuration of a hinge that connects the movable part 36 to the fixed part 37, allowing the mutual rotation of the two members.

In other words, while in the first described embodiment the pivoting axis of the articulation means 100 is parallel to and coincides with the longitudinal axis of the movable part 36 and of the fixed part 37, in this further embodiment the pivoting axis of the articulation means 10100 is transverse to the longitudinal axis of the movable part and of the fixed part.

In the embodiment shown in FIG. 5, the elements that correspond to the elements of the embodiment shown in FIGS. 1 to 4, have been designated by the same reference numerals.

The operation of a labeling machine according to the present invention is evident from what has been described above.

In particular, it is evident that in order to replace the reel it is sufficient to release the removable locking means 130 and act on the operating lever 140 so as to easily pass from the working position to the loading position, by virtue of the articulation means 100.

In the loading position, the rotation axis 3000 of the rotatable support 31 is substantially horizontal and in this condition it is possible to unload and load the reels with maximum safety for the operators, while ensuring very short and repeatable machine downtimes.

In order to release the movable part, it is sufficient to act on the knob 135 so as to disengage the shank 136 from the locking seats 132a and 132b, thus being able to perform the free rotation of the movable part 36 with respect to the fixed part 37.

The return to the working position occurs in substantially similar manners.

In practice it has been found that the labeling machine, particularly of the reel-fed type, according to the invention, fully achieves the intended aim, by making the operations for loading the reels on the reel holders particularly easy even in the case of heavy and bulky reels.

Also, the labeling machine according to the invention is capable of ensuring maximum safety for operators, while minimizing the time required for the operations that are auxiliary with respect to the actual labeling.

This application claims the priority of Italian Patent Application No. VI2011A000250, filed on Sep. 16, 2011, the subject matter of which is incorporated herein by reference.

1. A labeling machine, particularly of the reel-fed type, comprising a framework (2) which supports an application means (10) provided with at least one rotating member (11) adapted to transfer individual labels on corresponding containers moved by a conveyance means (50); said application assembly (10) is fed by a driving means (20) which unwinds a labels ribbon from a reel which is supported by a rotatable support (31) mounted on at least one reel supporting assembly (30); said labeling machine (1) is characterized in that it comprises an articulation means (100) which moves said reel supporting assembly (30) from a working position to a loading position and vice versa; in said working position, a rotation axis (3000) of said rotatable support (31) is substantially parallel to a rotation axis (1000) of said rotating member (11), whereas in said loading position, the rotation axis (3000) of said rotatable support (31) is transverse to the rotation axis (1000) of said rotating member (1).

2. The labeling machine according to claim 1, characterized in that said reel supporting assembly (30) comprises an arm comprising a fixed part (37) and a movable part (36), which are associated by said articulation means (100); said fixed part (37) being integral with said framework (2); said movable part (36) being associated with said rotating support (31).

3. The labeling machine according to claim 2, characterized in that said articulation means (100) comprises a pivot (110) which is rotatably accommodated in a complementarily shaped seat (120);
said pivot (110) and said seat (120) being provided at the ends of said fixed part (37) and of said movable part (36), substantially at the region of connection between said fixed part (37) and said movable part (36).

4. The labeling machine according to claim 3, characterized in that said seat (120) is provided in a flanged sleeve (121) which is detachably inserted in a hollow portion of said movable part (36) or of said fixed part (37), substantially at a connecting region between said fixed part and said movable part.

5. The labeling machine according to claim 4, characterized in that said pivot (110) is rotatably mounted on a friction reducing means (111 , 112) which is accommodated within said flanged sleeve (121).

6. The labeling machine according to claim 2, characterized in that said articulation means comprises a hinge which is arranged substantially at the connecting region between said fixed part (37) and said movable part (36).

7. The labeling machine according to claim 3, characterized in that said arm comprises a removable locking means which acts between said movable part and said fixed part; said locking means can be accessed substantially at the connecting region between said fixed part and said movable part.

8. The labeling machine according to claim 7, characterized in that said locking means comprises a cylindrical body which is fixed to the free end of said pivot; said cylindrical body forms at least one pair of locking seats for the insertion of a detent which is associated with said hollow portion, substantially at said seat.

9. The labeling machine according to claim 8, characterized in that said detent comprises a cylinder which can slide radially with respect to said cylindrical body; said cylinder has, at its accessible end, a knob and, at the opposite end, a shank which can be inserted in said locking seats; said shank being extractable from said locking seats by overcoming the action of an elastic contrast means.

10. The labeling machine according to claim 2, characterized in that said arm comprises at least one operating lever (140), which is joined to said movable part (36) in order to facilitate transition from said working position to said loading position and vice versa.

11. The labeling machine according to claim 2, characterized in that said arm comprises a removable locking means which acts between said movable part and said fixed part; said locking means can be accessed substantially at the connecting region between said fixed part and said movable part.
